(19) United States
(12) Patent Application Publication
(10) Pub. No.: US 2010/0332536 A1
(43) Pub. Date: Dec. 30, 2010

(54) ASSOCIATING ATTRIBUTE INFORMATION WITH A FILE SYSTEM OBJECT

(75) Inventors: Anantha Keerthi Banavara RAMASWAMY, BANGALORE (IN); Arun Avanna VIJAYAKUMAR, BANGALORE (IN)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/546,954

(22) Filed: Aug. 25, 2009

(30) Foreign Application Priority Data
Jun. 30, 2009 (IN) 1541/CHE/2009

(51) Int. Cl. G06F 17/30

(52) U.S. Cl. 707/770; 707/822; 707/769; 707/759

(57) ABSTRACT

Attribute information is associated with a file system object that is part of a distributed file system stored in a server system. In response to a request for the file system object from a first client, the attribute information associated with the file system object is accessed. The accessed attribute information allows for differentiated treatment in processing the request for the file system object from the first client as compared to a request for the file system object received from another client.

### BACKGROUND

A distributed file system allows remote access, by one or more client nodes, of files that may be physically distributed across a network on one or more server nodes. The distributed file system allows the distributed files to appear as if the files reside in one location on the network. Effectively, a distributed file system provides transparent remote access to files in a network, which allows users at client nodes to share objects (files and directories) of the distributed file system. A file system residing on a server node can be accessed by a client node by mounting or mapping the file system on the client node such that the mounted file system will look to a user at the client node as if the file system resides on the client node.

Examples of distributed file systems include the Network File System (NFS), which is described in Request for Comments (RFC) 1094, entitled “NFS: Network File System Protocol Specification,” dated March 1989; RFC 1813, entitled “NFS Version 3 Protocol Specification,” dated June 1995; and RFC 3530, entitled “Network File System (NFS) Version 4 Protocol,” dated April 2003. Another example of a distributed file system is the Common Internet File System as defined by the Storage Networking Industry Association (SNIA).

Although distributed file systems allow for relatively convenient access by users of remotely located (and distributed) files, conventional distributed file systems do not offer various features that improve efficiency in accessing objects of the distributed file systems.

### BRIEF DESCRIPTION OF THE DRAWINGS

Some embodiments of the invention are described with respect to the following figures:

FIG. 1 is a block diagram of an exemplary arrangement that incorporates a distributed file system according to an embodiment;

FIG. 2 is a schematic diagram of a layout of embedded enablers that provide attribute information that can be associated with a file system object, according to an embodiment;

FIG. 3 is a flow diagram of processing a read request, according to an embodiment;

FIG. 4 is a flow diagram of a process of processing a write request, according to an embodiment; and

FIG. 5 is a flow diagram of a process of processing an operation on a file system object based on tuneable attributes in the embedded enabler according to an embodiment.

### DETAILED DESCRIPTION

An issue associated with conventional distributed file systems is that they generally do not provide a technique for providing differentiated processing of requests for file system objects (e.g., files or directories) at the file system object granularity. As one example, in response to requests for accessing a particular file system object from multiple clients, a conventional distributed file system may not be able to efficiently prioritize the multiple requests for the file system object from the multiple clients. As another example, a conventional distributed file system may not be able to efficiently adapt processing of requests for a particular file system object in light of previous access patterns related to the particular file system object.

In accordance with some embodiments, attribute information can be associated with file system objects such that differentiated processing of requests for file system objects can be provided at the granularity of the file system objects. As noted above, a file system object can either be a file or a directory. A “file” refers to a collection of data that is maintained by the file system. A directory is a hierarchical structure that contains one or more files and possibly one or more subdirectories. A subdirectory is a hierarchical structure that can contain one or more files and possibly further subdirectories.

The differentiated processing of requests that is enabled by the attribute information associated with the file system objects includes one or more of the following: (1) in processing requests for a particular file system object, different priorities can be assigned to different requesting clients such that some clients are provided higher priority for accessing the particular file system object than other clients; (2) adaptive readahead (readahead that is able to learn based on past patterns to predict what other data to retrieve) operations can be specified for the file system objects, where an adaptive readahead operation refers to retrieving additional data not yet requested based on prior access patterns associated with a file system object; and (3) other types of differentiated processing where tuneable processing is applied to different clients and/or file system objects based on the attribute information.

The ability to assign higher priority to some clients over other clients allows for more responsive and efficient file system operations can be achieved. One example type of a low priority client is a client that belongs to a data backup domain. Such a client sends requests to a file system to perform backup of data. If there are other requests associated with higher priority clients pending, then any requests associated with a client in the data backup domain would be performed after requests for the higher priority clients have been processed.

In addition, the attribute information can also specify a domain (of a client) and time at which a backup of a file system object (such as a directory) is to be performed with a specified priority. Normally, during business hours, backup operations are performed when computing resources, such as server(s), are not otherwise busy. However, the attribute information associated with a particular file system object may specify a time at which the backup operation for the particular file system object should be given a higher priority. More generally, the attribute information allows a behavior (e.g., its priority) of a backup operation to change.

Performing adaptive readahead increases the likelihood that future requests can be satisfied from readahead data (read a priori) stored in storage media having higher access speeds. Performing adaptive readahead (which is readahead according to recorded learning based on prior access patterns) reduces the likelihood that the data retrieved by the readahead operation is a wasted operation, which improves efficiency of usage of network bandwidth.

In some embodiments, the attribute information that is associated with a file system object is referred to as an “embedded enabler.” In a more specific implementation, embedded enablers can be provided in (embedded in) named data streams (NDS) or alternatively named streams. A named data stream provides a mechanism for storing and retrieving values for user-defined attributes associated with a file system object. Basically, a named data stream is a container (or placeholder) for storing metadata associated with a file system object.

If the file system object that an embedded enabler is associated with is a directory, then the embedded enabler can have a hierarchical structure. The hierarchical structure of the embedded enabler corresponds to the hierarchical structure of the directory, where different levels of the hierarchy of the embedded enabler would correspond to different hierarchical levels of the directory.

By embedding embedded enablers in named data streams, the behavior of processing requests for a particular file system object can be controlled at the granularity of the file system object, which can enhance flexibility and efficiency. Using a tool, administrators can modify the embedded enablers associated with file system objects to modify the behaviors associated with processing of requests for the corresponding file system objects.

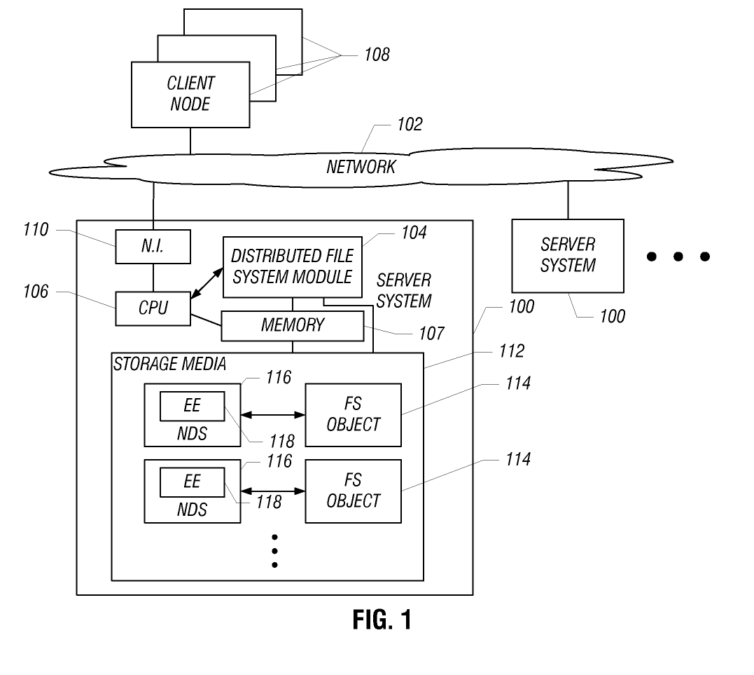

FIG. 1 illustrates an exemplary arrangement that includes server systems 100 that are connected to a network 102. Each server system 100 includes a distributed file system module 104, which can be software executable on one or more central processing units (CPUs) 106 in the server system 100. The one or more CPUs 106 are connected to memory 107 (which can be implemented with relatively high-speed storage media such as integrated circuit memory devices). The distributed file system modules 104 in the server systems 100 cooperate to implement a distributed file system that allows client nodes 108 to share objects that are part of the distributed file system. Although multiple server systems 100 are shown in FIG. 1, it is noted that in alternative implementations, a single server system 100 can be employed. A distributed file system provides transparent remote access to files in a network, which allows users at client nodes to share objects (files and directories) of the distributed file system.

The server system 100 includes a network interface 110 to allow the server system 100 to communicate over the network 102. In addition, the server system 100 includes storage media 1 12, which can be implemented with disk-based storage device(s), integrated circuit storage device(s), and/or other types of storage devices. The storage media 112 is used to store file system objects 114 that are part of a distributed file system. A file system object 114 can be a file, or alternatively, the file system object 114 can be a directory.

As further shown in FIG. 1, each file system object 114 is associated with a corresponding named data stream 116. In accordance with some embodiments, one or more embedded enablers (EE) 118 are embedded in each corresponding named data stream 116. The embedded enabler(s) 118 can be modified (tuned) to provide differentiated treatment in processing requests for the associated file system object 114.

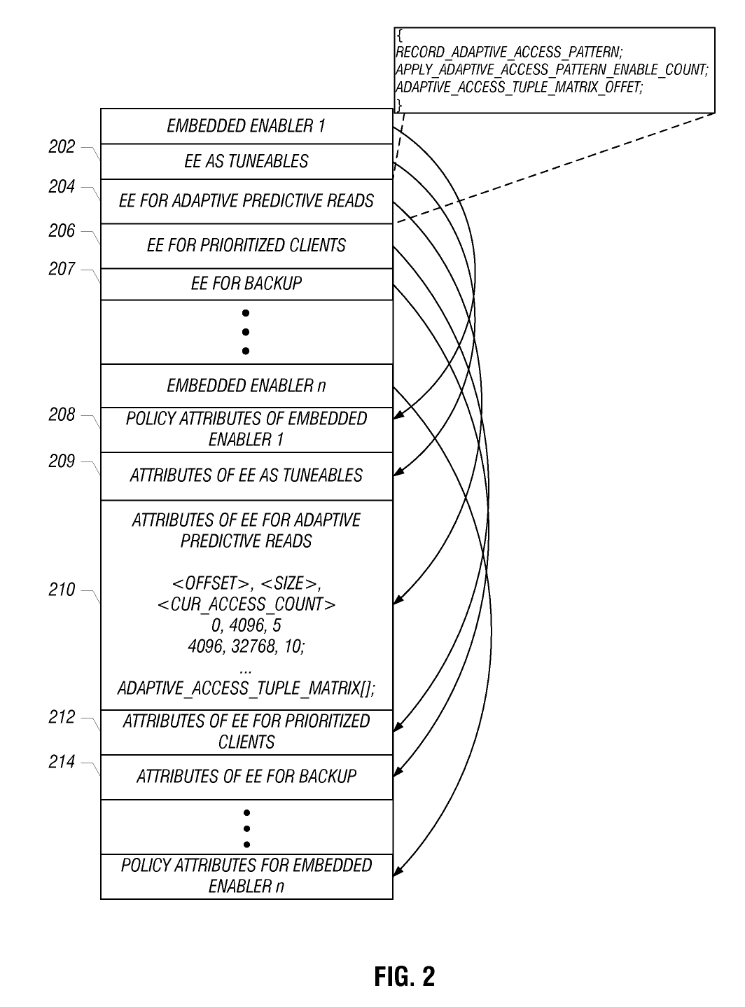

FIG. 2 illustrates the layout of embedded enablers associated with a file system object. Note that just a single or multiple embedded enablers can be associated with each file object. If the file system object is a directory, then different ones of the embedded enablers may be associated with different entries in the directory. For example, one or more of the embedded enablers may be associated with the directory. Also, one or more of the embedded enablers may be associated with different entries in the directory. Alternatively, one or more of the embedded enablers may be associated with all objects (files and subdirectories) of the directory.

In the example of FIG. 2, n embedded enablers (1-n) are shown, where n≧1. In the example, embedded enabler 1 is associated with several header structures 202, 204, 206, and 207. The header structure 202 is referred to as an “EE as Tuneables” data structure, which contains attributes that can be adjusted to alter the behavior regarding processing of the corresponding file system object. The second header structure 204 shown in FIG. 2 is an “EE for Adaptive Predictive Reads” header structure that contains variables used for controlling adaptive readahead reading for the corresponding file system object. The third header structure 206 is referred to as an “EE for Prioritized Clients” header structure to control which clients are given higher priority than other clients when accessing (e.g. writing or reading) the corresponding file system object. The fourth header structure 207 is referred to as an “EE for Backup” header structure to specify variables for prioritized backup operation for the corresponding file system object.

The header structures 202, 204, 206, and 207 point to other portions of the embedded enabler layout that contain more detailed attribute information. For example, the EE as Tuneables header structure 202 points to a portion 209, while the EE for Adaptive Predictive Reads header structure 204 points to portion 210. The EE for Prioritized Clients data structure 206 points to portion 212. The EE for Backup header structure 207 points to portion 214.

The portion 209 contains various tuneable attributes that are adjustable to control behavior associated with processing of the corresponding file system object.

The portion 210 contains the attributes for adaptive readaheads. A data structure, referred to in this example as ADAPTIVE_ACCESS_TUPLE_MATRIX[ ] is used to store information representing data access patterns. More specifically, in the example shown in FIG. 2, the data structure ADAPTIVE_ACCESS_TUPLE_MATRIX[ ] stores three values: <offset> (which represents the logical offset of a block of data in the corresponding file system object); <size> (which represents the size of the block that begins at the specified offset); and <CUR_ACCESS_COUNT> (which represents the number of times the block represented by <offset> and <size> has been accessed). The value of <CUR_ACCESS_COUNT> is a running count that is incremented each time data in the corresponding offset-size block is accessed.

The EE for Adaptive Predictive Reads data structure 204 contains the following exemplary parameters: RECORD_ADAPTIVE_ACCESS_PATTERN (which signifies if recording of access patterns is to be turned on for the file system object); APPLY_ADPATIVE_ACCESS_PATTERN_ENABLE_COUNT (which signifies the minimum count value above which adaptive readahead can take effect, in other words the <CUR_ACCESS_COUNT> value has to be greater than APPLY_ADAPTIVE_ACCESS_PATTERN_ENABLE_COUNT for adaptive readahead to take effect on a corresponding block in the file system object); and ADAPTIVE_ACCESS_TUPLE_MATRIX_OFFSET (which is the offset within the named data stream where the data structure ADAPTIVE_ACCESS_TUPLE_MATRIX[ ] is found).

In some embodiments, adjacent records in the data structure ADAPTIVE_ACCESS_TUPLE_MATRIX[ ] can be coalesced such that the coalesced records are subject to the adaptive readahead.

The portion 212 (pointed to by the EE for Prioritized Clients header structure 206) contains information regarding which clients have priority for accesses of the file system object. For example, certain clients may be identified as being low priority clients, while other clients are identified as high priority clients.

The portion 214 (pointed to by the EE for Backup header structure 207) contains the following example attributes: domain (of client), and time information. The time information specifies a time at which a backup operation for file system object(s) of the specified domain (client) are to be backed up with a higher priority than normally given for backup operations during business hours.

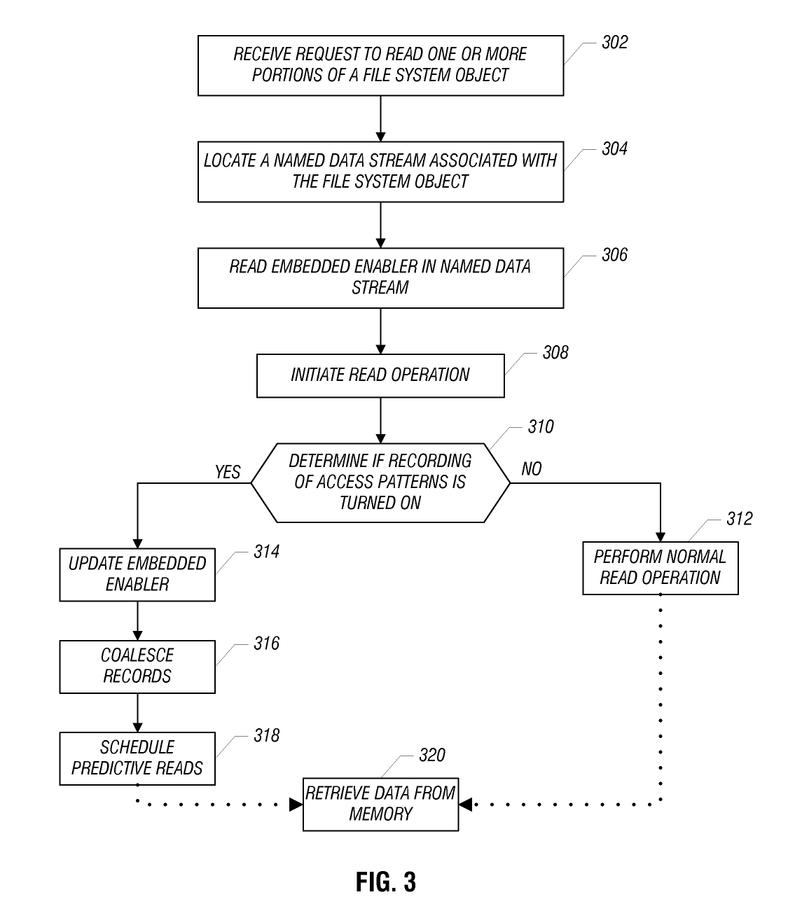

FIG. 3 is a flow diagram of a procedure associated with processing a read request. The procedure of FIG. 3 can be performed by the file system module 104 shown in FIG. 1. The file system module 104 receives (at 302) a request to read one or more portions of a file system object. In response to the request, the file system module 104 locates (at 304) the named data stream associated with the file system object. The file system module 104 then reads (at 306) the embedded enabler information in the named data stream.

A read operation is then initiated (at 308) for the requested portion(s) of the file system object. Next, the file system module 104 determines (at 310) if recording of access patterns is turned on—recording of access patterns allows adaptive readahead to be performed. Turning on recording of access patterns means that accesses of portions of file system objects are tracked and recorded. In the example of FIG. 2, checking whether recording of access patterns is turned on involves determining if the parameter RECORD_ADAPTIVE_ACCESS_PATTERN (in the EE for Adaptive Predictive Reads header structure 204) is true, which indicates that recording of access patterns has been turned on for the file system object. If the value of RECORD_ADAPTIVE_ACCESS_PATTERN is not true, then a normal read operation is performed (at 312).

However, if the value of RECORD_ADAPTIVE_ACCESS_PATTERN is true, then the data structure ADAPTIVE_ACCESS_TUPLE_MATRIX[ ] (in the portion 210 of the embedded enabler layout shown in FIG. 2) is updated (at 314). Updating this data structure involves incrementing the count value <CUR_ACCESS_COUNT> if an entry exists for the portion of the file system object that is being accessed. However, if an entry does not exist, then an entry is added to the data structure ADAPTIVE_ACCESS_TUPLE_MATRIX[ ].

In some embodiments, adjacent records in the data structure ADAPTIVE_ACCESS_TUPLE_MATRIX[ ] can be coalesced (at 316) such that the coalesced records are subject to the adaptive readahead.

Next, predictive reads are scheduled (at 318) based on the entries in the data structure ADAPTIVE_ACCESS_TUPLE_MATRIX[ ]. Scheduling of predictive reads can be based on the values of <CUR_ACCESS_COUNT> for corresponding blocks of the file system object. The value of <CUR_ACCESS_COUNT> can be compared to a threshold; if the value of <CUR_ACCESS_COUNT> does not exceed this threshold, then the corresponding block is not subject to predictive readahead. In some embodiments, the threshold can be set to be equal to some percentage of the mean (or other aggregation) of values of <CUR_ACCESS_COUNT> of the various blocks associated with the file system object. In other implementations, the threshold can be a fixed threshold.

Data that is read from the file system (including the requested data as well as readahead data) is retrieved (at 320) from the storage media 112 (FIG. 1) into the memory 107 (FIG. 1) of the server system 100 for subsequent access. The memory 107 is implemented with storage devices having higher access speeds than the storage media 112, such that any subsequent access operations that can be satisfied from the memory 107 can be completed more quickly.

In some cases, some portions of large files (such as database files or indexes) may be frequently accessed. If adaptive readahead is turned on for such large files, then access patterns can be recorded in the corresponding embedded enablers and the portions that are frequently accessed are retained in the memory 107 (rather than the entire large files). Having the access information placed in the named data stream associated with a file system object will provide the ability for the administrator to control the caching mechanism at the file system object granularity. Moreover, this allows adaptability of the file system module 104 to help improve the responsiveness of the server system 100.

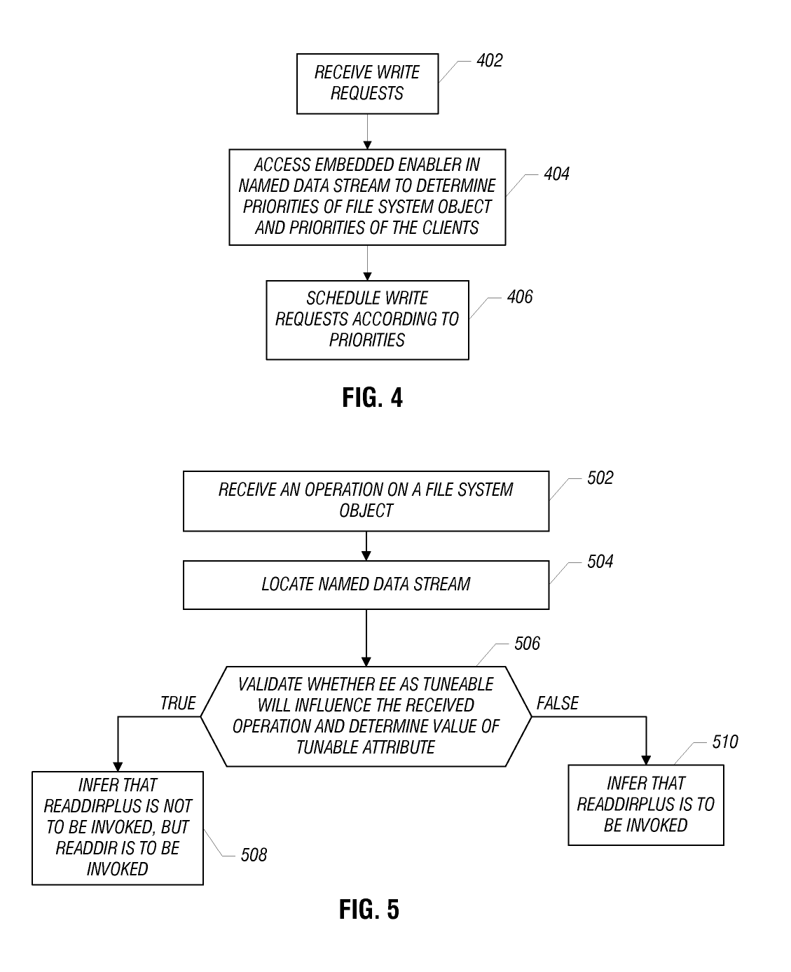

FIG. 4 is a flow diagram of a procedure for processing write requests. The file system module 104 receives (at 402) write requests (modify or create requests), which may be received from different clients for a particular file system object. Next, the file system module 104 accesses (at 404) the named data stream associated with the particular file system object to determine the relative priorities of the file system object and the clients that have submitted requests for the particular file system object. In particular, the file system module 104 accesses the EE for Prioritized Clients header structure 206 of the corresponding embedded enabler to determine priority information for the file system object and the clients. The distributed file system module 104, based on the priority level of the client and the particular file system object, can choose to queue (in the module's internal queue) the write requests or choose to handle the write requests ahead of the other requests from the client (as compared to other file system objects). Based on the priority levels of the various clients, the write requests can be scheduled (at 406) by the file system module 104. The request of the higher priority clients are scheduled ahead of the requests of lower priority clients.

A named data stream can also include tuneable attributes (associated with the EE as Tuneables header structure 202 shown in FIG. 2) that can be adjusted by a user to control the behavior of the file system module 104 on a per-file system object basis. For example, according to the Network File System (NFS) protocol, two procedures for reading a directory are provided: READDIR and READDIRPLUS. The procedure READDIRPLUS provides more information than the READDIR procedure. If a directory has a very large number of files (thousands or tens of thousands of files) residing in the directory, an application running on the client may not be interested in detailed information that may be provided by the READDIRPLUS procedure. In this case, tuneable attributes can be provided in the embedded enablers to specify that the READDIR procedure is to be used to list the files in the particular directory, rather than using the READDIRPLUS procedure. On the other hand, an application running on a client may be performing extensive operations on the particular directory, in which case the application on the client may benefit from receiving additional information provided by the READDIRPLUS procedure.

FIG. 5 is a flow diagram of an example in which an EE as Tuneables attribute (209 in FIG. 2) is checked in processing an operation on a file system object. More specifically, in FIG. 5, an EE as Tuneables attribute is checked to determine whether READDIRPLUS or READDIR is to be used for listing content of a directory. An operation on a file system object is received (at 502), where the operation in this example is a request to list the content of a directory. In response to the operation, the named data stream associated with the particular file system object is located (at 504).

Next, the embedded enabler information in the named data stream is read (at 504). The file system module then validates (at 506) whether the EE as Tuneables attribute will influence the received operation. In one example, the file system module determines (at 506) if the corresponding tuneable attribute value is true. In this example, if the EE as Tuneables attribute is true, then the distributed file system module 104 infers that the READDIRPLUS procedure is not to be invoked (at 508), but rather that the READDIR operation is to be invoked However, if the EE as Tuneables attribute is false, then the distributed file system module 104 infers that the READDIRPLUS procedure is to be invoked (at 510).

Instructions of software described above (including the file system modules 104 of FIG. 1) are loaded for execution on a processor (such as one or more CPUs 106 in FIG. 1). The processor includes microprocessors, microcontrollers, processor modules or subsystems (including one or more microprocessors or microcontrollers), or other control or computing devices. As used here, a “processor” can refer to a single component or to plural components (e.g., one CPU or multiple CPU on one computer or multiple computers).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
associating attribute information with a file system object that is part of a distributed file system stored in a server system; and
in response to a request for the file system object from a first client, accessing the attribute information associated with the file system object, wherein the accessed attribute information allows for differentiated treatment in processing the request for the file system object from the first client as compared to a request for the file system object received from another client.

2. The method of claim 1, wherein associating the attribute information with the file system object comprises associating attribute information that also specifies that adaptive readahead is to be performed for the file system object.

3. The method of claim 2, further comprising:
in response to the attribute information specifying that adaptive readahead is to be performed, performing readahead of data in response to a request for a portion of the file system object.

4. The method of claim 3, wherein performing the readahead comprises performing adaptive readahead based on a prior access pattern associated with the file system object.

5. The method of claim 4, further comprising:
in response to the attribute information specifying that adaptive readahead is to be performed, recording the access pattern associated with the file system object.

6. The method of claim 5, wherein recording the access pattern comprises recording counts of accesses of portions of the file system object, and wherein performing the readahead of data comprises performing the readahead of at least a subset of the portions based on the recorded counts.

7. The method of claim 1, wherein associating the attribute information with the file system object comprises associating attribute information having at least one attribute settable to plural values to cause different behaviors with respect to the file system object.

8. The method of claim 1, wherein associating the attribute information with the file system object comprises associating attribute information that specifies a changed behavior for a backup operation.

9. The method of claim 1, wherein the differentiated treatment in processing the request for the file system object from the first client as compared to the request for the file system object received from another client comprises assigning a different priority to the request for the file system object from the first client as compared to the request for the file system object received from the other client.

10. The method of claim 1, wherein associating the attribute information with the file system object comprises associating the attribute information with a file or directory.

11. The method of claim 1, wherein associating the attribute information with the file system object comprises embedding the attribute information in a named data stream associated with the file system object.

12. A server computer comprising:
storage media to store file system objects and attribute information associated with corresponding ones of the file system objects; and
a processor to:
receive a request for a particular one of the file system objects;
in response to the request, determine whether readahead is to performed by accessing the attribute information associated with the particular file system object; and
in response to determining that readahead is to be performed, retrieving readahead data from the storage media.

13. The server computer of claim 12, further comprising a readahead module executable on the processor, wherein the readahead module is to cooperate with one or more other readahead modules in one or more other server computers to provide a distributed file system.

14. The server computer of claim 12, wherein the attribute information associated with the particular file system object indicates that adaptive readahead is to be performed based on a prior access pattern in response to the request for the particular file system object.

15. The server computer of claim 14, wherein the attribute information associated with the particular file system object is to record the prior access pattern.

16. The server computer of claim 12, wherein the attribute information associated with another of the file system objects specifies that certain clients are assigned higher priority than other clients for the another file system object.

17. The server computer of claim 12, wherein the attribute information associated with another of the file system objects contains at least one attribute settable to different values to specify different behaviors for processing requests for the another file system object.

18. An article comprising at least one computer-readable storage medium containing instructions that upon execution by a computer system cause the computer system to:
store attribute information with a file system object of a distributed file system, wherein the attribute information is to indicate one or more of the following: readahead of data is to be performed in response to a request for the file system object; and at least one client is to be assigned a higher priority for accessing the file system object compared to at least another client; and
in response to receiving a request for the file system object, access the attribute information to perform an action associated with the file system object.

19. The article of claim 18, wherein the attribute information and file system object are part of the distributed file system implemented across multiple computer systems.

20. The article of claim 18, wherein the attribute information further has at least one attribute settable to plural values to cause different behaviors with respect to the file system object.
